(19) United States
(12) Patent Application Publication
(10) Pub. No.: US 2022/0223838 A1
(43) Pub. Date: Jul. 14, 2022

(54) NEGATIVE ELECTRODE ACTIVE MATERIAL, LITHIUM-ION BATTERY, AND METHOD OF PRODUCING NEGATIVE ELECTRODE ACTIVE MATERIAL

(71) Applicant: Prime Planet Energy & Solutions, Inc., Tokyo (JP)

(72) Inventor: Iwao NITTA, Kobe-shi (JP)

(21) Appl. No.: 17/570,277

(22) Filed: Jan. 6, 2022

(30) Foreign Application Priority Data
Jan. 13, 2021 (JP) 2021-003442

(51) Int. Cl. H01M 4/36; H01M 10/0525; H01M 4/62; H01M 4/38; H01M 4/587; C01B 32/20; C01B 33/02; C01B 33/12; B01J 23/72; C01B 32/162

(52) U.S. Cl. CPC H01M 4/364; H01M 10/0525; H01M 4/625; H01M 4/38; H01M 4/587; H01M 2004/027; C01B 33/02; C01B 33/12; B01J 23/72; C01B 32/162; C01B 32/20

(57) ABSTRACT

The negative electrode active material includes a first composite particle. The first composite particle includes a first active material particle, a second active material particle, an electronic conductor, and a solid electrolyte film. The first active material particle includes an alloy-based negative electrode active material. The second active material particle includes graphite. The electronic conductor is placed on a surface of the first active material particle. The solid electrolyte film covers the first active material particle. At least part of the electronic conductor is embedded in the solid electrolyte film. The second active material particle supports the first active material particle, the solid electrolyte film, and the electronic conductor.

This nonprovisional application is based on Japanese Patent Application No. 2021-003442 filed on Jan. 13, 2021, with the Japan Patent Office, the entire contents of which are hereby incorporated by reference.

### BACKGROUND OF THE INVENTION

### Field of the Invention

The present technique relates to a negative electrode active material, a lithium-ion battery, and a method of producing a negative electrode active material.

### Description of the Background Art

International Patent Publication No. WO 2014/046144 discloses a composite graphite particle including a metal particle and graphite.

### SUMMARY OF THE INVENTION

For a lithium-ion battery (which may be simply called “battery” hereinafter), an alloy-based negative electrode active material has been researched. An alloy-based negative electrode active material (such as silicon, for example) may have a large specific capacity. However, an alloy-based negative electrode active material tends to undergo a great extent of volume change during charge and discharge. The volume change of an alloy-based negative electrode active material may facilitate electrode collapse. There is a demand for a method for suppressing the volume change of an alloy-based negative electrode active material.

It is suggested to cause graphite to support an alloy-based negative electrode active material to form composite particles. Graphite is a widely used negative electrode active material. It is expected that the graphite can function as a cushioning material in the composite particles to suppress the volume change of the alloy-based negative electrode active material. However, in the composite particles, the utilization rate of the alloy-based negative electrode active material tends to be low. Therefore, there is a possibility that a desired level of capacity cannot be obtained.

An object of the technique according to the present application (herein also called “the present technique”) is to enhance the utilization rate of an alloy-based negative electrode active material in composite particles including an alloy-based negative electrode active material and graphite.

Hereinafter, the configuration and effects of the present technique will be described. It should be noted that the action mechanism according to the present technique includes presumption. The scope of the present technique should not be limited by whether or not the action mechanism is correct.

[1] A negative electrode active material is for a lithium-ion battery. The negative electrode active material includes a first composite particle. The first composite particle includes a first active material particle, a second active material particle, an electronic conductor, and a solid electrolyte film. The first active material particle includes an alloy-based negative electrode active material. The second active material particle includes graphite. The electronic conductor is placed on a surface of the first active material particle. The solid electrolyte film covers the first active material particle. At least part of the electronic conductor is embedded in the solid electrolyte film. The second active material particle supports the first active material particle, the solid electrolyte film, and the electronic conductor.

The composite particle according to the present technique includes a first active material particle (an alloy-based negative electrode active material) and a second active material particle (graphite). According to new findings from the present technique, in the composite particle, contact between the alloy-based negative electrode active material and an electrolyte solution may be hindered by graphite. For example, when the alloy-based negative electrode active material is enclosed within graphite, the alloy-based negative electrode active material cannot come into contact with the electrolyte solution; more specifically, the alloy-based negative electrode active material cannot directly transfer lithium (Li) ions to and from the electrolyte solution. The alloy-based negative electrode active material needs to transfer Li ions to and from the electrolyte solution, through graphite. This can cause irregularity in reactivity depending on the position of the alloy-based negative electrode active material within the composite particle, which can cause a decrease in the utilization rate of the alloy-based negative electrode active material.

Moreover, when there are only few contact points between the alloy-based negative electrode active materials and the electrolyte solution, contact points between the alloy-based negative electrode active materials and graphite should serve as the main Li-ion conduction paths to reach the alloy-based negative electrode active materials. This means that there are few Li-ion conduction paths for Li ions to move through in and out of the alloy-based negative electrode active materials, which can be a bottleneck and can cause a decrease in the utilization rate of the alloy-based negative electrode active material.

The first composite particle according to the present technique includes a solid electrolyte film. The solid electrolyte film covers the first active material particle (alloy-based negative electrode active material). The solid electrolyte film is a Li-ion conductor. In other words, the solid electrolyte film may form Li-ion conduction paths. With the solid electrolyte film covering the alloy-based negative electrode active material, Li-ion conduction paths may be formed substantially evenly around the alloy-based negative electrode active material. This is expected to decrease the irregularity in reactivity that can occur depending on the position of the alloy-based negative electrode active material within the composite particle. Further, with the solid electrolyte film covering the alloy-based negative electrode active material, Li-ion conduction paths (ionic contact points) between the alloy-based negative electrode active material and graphite are expected to be increased.

Moreover, an alloy-based negative electrode active material tends to undergo a great extent of volume change during charge and discharge. The volume change of an alloy-based negative electrode active material may cause a break of the alloy-based negative electrode active material and/or a loss of contact points between the alloy-based negative electrode active material and graphite. This causes a decrease of electron conduction paths to reach the alloy-based negative electrode active material. Because there are thus few electron conduction paths to reach the alloy-based negative electrode active material, the utilization rate of the alloy-based negative electrode active material can be decreased.

The first composite particle according to the present technique includes an electronic conductor. The electronic conductor is placed on a surface of the alloy-based negative electrode active material. The electronic conductor may form electron conduction paths (electronic contact points) between the alloy-based negative electrode active material and graphite. A part of the electronic conductor is embedded in the solid electrolyte film. In other words, a part of the electronic conductor is fixed to a surface of the alloy-based negative electrode active material. It seems that, because of this, even when the volume of the alloy-based negative electrode active material changes, the electronic conductor is less likely to be separated from the alloy-based negative electrode active material. That is, it seems that the electron conduction paths are less likely to be lost.

The above-described actions may synergistically enhance the utilization rate of the alloy-based negative electrode active material in the present technique.

[2] In [1] above, a plurality of the first composite particles may be aggregated to form a second composite particle. A plurality of the first active material particles may be dispersed inside the second composite particle.

With a plurality of the alloy-based negative electrode active materials being dispersed inside the second composite particle, the utilization rate of the alloy-based negative electrode active material is expected to be enhanced, for example.

[3] In [2] above, the negative electrode active material may further include an amorphous carbon film. The amorphous carbon film may cover the second composite particle.

With the second composite particle being covered with the amorphous carbon film, graphite cycling performance and/or storage properties is expected to be enhanced, for example.

[4] In [1] to [3] above, a part of the electronic conductor may be exposed from the solid electrolyte film.

With a part of the electronic conductor being exposed from the solid electrolyte film, electron conduction paths for connecting the alloy-based negative electrode active material and graphite are expected to be increased.

[5] In [1] to [4] above, the electronic conductor may include fibrous carbon, for example.

With the electronic conductor including fibrous carbon, electron conduction paths are expected to be formed across a wide area. This is expected to enhance the utilization rate of the alloy-based negative electrode active material.

[6] In [5] above, the electronic conductor may further include a metal nanoparticle. The metal nanoparticle may be placed on a surface of the first active material particle. The fibrous carbon may extend, starting from the metal nanoparticle in a direction away from the metal nanoparticle.

The electronic conductor may be, for example, a composite of carbon and metal. For example, the metal nanoparticle may be placed on a surface of the alloy-based negative electrode active material. The metal nanoparticle may be used as a catalyst to cause the fibrous carbon to grow. By this, an electronic conductor may be formed extending toward outside from the surface of the alloy-based negative electrode active material. [7] A lithium-ion battery includes the negative electrode active material according to [1] to [6] above.

The battery according to the present technique is expected to have a high capacity.

[8] A method of producing a negative electrode active material includes the following (A) to (C):

(A) placing an electronic conductor on a surface of a first active material particle;

(B) after the placing an electronic conductor, covering the first active material particle with a solid electrolyte film; and

(C) forming a first composite particle by causing a second active material particle to support the first active material particle covered with the solid electrolyte film.

The first active material particle includes an alloy-based negative electrode active material. The second active material particle includes graphite.

By the method of producing a negative electrode active material according to [8] above, the negative electrode active material according to [1] above may be produced. With the configuration in which the electronic conductor is placed on a surface of the alloy-based negative electrode active material and then the solid electrolyte film is formed, a part of the electronic conductor may be embedded in the solid electrolyte film.

[9] In [8] above, the method of producing a negative electrode active material may include the following (a2) and (a3), for example:

(a2) placing a metal nanoparticle on the surface of the first active material particle; and

(a3) synthesizing fibrous carbon by using the metal nanoparticle as a catalyst to form the electronic conductor.

By the method of producing a negative electrode active material according to [9] above, the negative electrode active material according to [5] or [6] above may be produced.

[10] In [8] or [9] above, the method of producing a negative electrode active material may further include the following (D):

(D) forming a second composite particle by aggregating a plurality of the first composite particles.

By the method of producing a negative electrode active material according to [10] above, the negative electrode active material according to [2] above may be produced.

[11] In [10] above, the method of producing a negative electrode active material may include performing spheronization treatment on the second composite particle.

With the spheronization treatment thus performed on the second composite particle, the first active material particle (an alloy-based negative electrode active material) may become enclosed within the second composite particle.

[12] In [10] or [11] above, the method of producing a negative electrode active material may include covering the second composite particle with an amorphous carbon film.

By the method of producing a negative electrode active material according to [12] above, the negative electrode active material according to [3] above may be produced.

The foregoing and other objects, features, aspects and advantages of the present technique will become more apparent from the following detailed description of the present technique when taken in conjunction with the accompanying drawings.

### BRIEF DESCRIPTION OF THE DRAWINGS

FIG. 1 is a conceptual view illustrating a first composite particle according to the present embodiment.

FIG. 2 is a conceptual view illustrating a second composite particle according to the present embodiment.

FIG. 3 is a conceptual view illustrating a surface region and a central region.

FIG. 4 is a schematic flowchart illustrating a method of producing a negative electrode active material according to the present embodiment.

FIG. 5 illustrates a concept of the flow of a method of producing a negative electrode active material according to the present embodiment.

FIG. 6 is a schematic view illustrating an example of a lithium-ion battery according to the present embodiment.

FIG. 7 is a schematic view illustrating an example of an electrode assembly according to the present embodiment.

FIG. 8 is a bar chart for evaluation results.

### DESCRIPTION OF THE PREFERRED EMBODIMENTS

Next, an embodiment of the present technique (also called “the present embodiment” hereinafter) will be described. It should be noted that the below description does not limit the scope of the present technique.

A singular form (“a”, “an”, and “the”) herein also includes its plural meaning, unless otherwise specified. For example, “a particle” may include not only “a single particle” but also “a group of particles (powder, particles)”.

Expressions such as “comprise, include” and “have”, and other similar expressions (such as “be composed of”, “encompass, involve”, “contain”, “carry, support”, and “hold”, for example) herein are open-ended expressions. In other words, each of these expressions means that a certain configuration is included but this configuration is not necessarily the only configuration that is included. The expression “consist of” is a closed-end expression. The expression “consist essentially of” is a semiclosed-end expression. In other words, the expression “consist essentially of” means that an additional component may also be included in addition to an essential component or components, unless an object of the present technique is impaired. For example, a component that is usually expected to be included in the relevant field to which the present technique pertains (such as inevitable impurities, for example) may also be included as an additional component.

The order to implement two or more steps, operations, processes, and the like included in a method herein is not particularly limited to the described order, unless otherwise specified. For example, two or more steps may proceed simultaneously.

In the present specification, when a compound is represented by a stoichiometric composition formula such as “LiCoO₂”, this stoichiometric composition formula is merely a typical example. The composition ratio may be non-stoichiometric. For example, when lithium cobalt oxide is represented as “LiCoO₂”, the composition ratio of lithium cobalt oxide is not limited to “Li/Co/O=1/1/2” but Li, Co, and O may be included in any composition ratio, unless otherwise specified.

Any geometric term herein (such as “perpendicular”, for example) should not be interpreted solely in its exact meaning. For example, “perpendicular” may mean a geometric state that is deviated, to some extent, from exact “perpendicular”. Any geometric term herein may include tolerances and/or errors in terms of design, operation, production, and/or the like. Moreover, the dimensional relationship in each figure may not necessarily coincide with the actual dimensional relationship. The dimensional relationship (in length, width, thickness, and the like) in each figure may have been changed for the purpose of assisting the understanding of the present technique. Further, a part of a configuration may have been omitted.

A numerical range such as “from 1 μm to 50 μm” or “from 1 to 50 μm” herein includes both the upper limit and the lower limit, unless otherwise specified. For example, “from 1 μm to 50 μm” means a numerical range of “not less than 1 μm and not more than 50 μm”. Moreover, any numerical value selected from a certain numerical range may be used as a new upper limit and/or a new lower limit. For example, any numerical value from a certain numerical range and any numerical value described in another location of the present specification may be combined to create a new numerical range.

<Negative Electrode Active Material>

A negative electrode active material according to the present embodiment is for a lithium-ion battery. The lithium-ion battery is described below in detail. The negative electrode active material includes a first composite particle.

<<First Composite Particle>>

FIG. 1 is a conceptual view illustrating the first composite particle according to the present embodiment.

A first composite particle 10 includes a first active material particle 11, a second active material particle 12, an electronic conductor 13, and a solid electrolyte film 14. For example, first composite particle 10 may consist essentially of first active material particle 11, second active material particle 12, electronic conductor 13, and solid electrolyte film 14.

(First Active Material Particle)

First active material particle 11 includes an alloy-based negative electrode active material. For example, first active material particle 11 may consist essentially of an alloy-based negative electrode active material. The “alloy-based negative electrode active material” herein may undergo electrochemical reaction (lithiation) to form an alloy with Li and may undergo electrochemical reaction (delithiation) to release Li. The alloy-based negative electrode active material may have a large specific capacity (mAh/g) compared to graphite.

The alloy-based negative electrode active material may consist essentially of a metal, for example. The metal herein includes a semimetal. The alloy-based negative electrode active material may include, for example, at least one selected from the group consisting of silicon (Si), arsenic (As), tin (Sn), aluminum (Al), antimony (Sb), bismuth (Bi), zinc (Zn), indium (In), and phosphorus (P). The alloy-based negative electrode active material may include at least one selected from the group consisting of Si, Sn, In, and Al. In addition to a metal and a semimetal, the alloy-based negative electrode active material may further include a non-metal. The alloy-based negative electrode active material may consist essentially of a metal compound, for example. The alloy-based negative electrode active material may include, for example, at least one selected from the group consisting of silicon oxide (SiO) and tin oxide (SnO).

First active material particle 11 is supported on second active material particle 12. First active material particle 11 may have any shape. First active material particle 11 may be spherical, plate-like, columnar, and/or the like, for example. First active material particle 11 may have a Feret diameter from 1 nm to 1 μm, for example. First active material particle 11 may include a nanoparticle, for example. When first active material particle 11 includes a nanoparticle, the influence of a volume change of first active material particle 11 (an alloy-based negative electrode active material) is expected to be reduced. The “nanoparticle” herein has a Feret diameter from 1 nm to 100 nm. The Feret diameters of individual particles may be measured with an STEM (scanning transmission electron microscope) and/or the like. The arithmetic mean of 100 Feret diameters is regarded as the Feret diameter of the measured target. First active material particle 11 may have a Feret diameter from 5 nm to 50 nm, or may have a Feret diameter from 10 nm to 30 nm, for example.

The amount of first active material particle 11 to be used is not limited. The mass fraction of first active material particle 11 (an alloy-based negative electrode active material) to second active material particle 12 (graphite) may be from 1% to 70%, or may be from 10% to 40%, or may be from 15% to 20%, for example.

(Second Active Material Particle) Second active material particle 12 includes graphite. For example, second active material particle 12 may consist essentially of graphite. The graphite may be artificial graphite, or may be natural graphite. In addition to graphite, second active material particle 12 may further include soft carbon, hard carbon, low-crystalline carbon, and/or the like.

Second active material particle 12 is a base material of first composite particle 10. Second active material particle 12 supports first active material particle 11, electronic conductor 13, and solid electrolyte film 14. Second active material particle 12 may have any shape. Second active material particle 12 may have a flake form, a spherical form, and/or the like, for example. Second active material particle 12 may have a D50 from 1 μm to 50 μm, for example. The “D50” herein refers to a particle size in volume-based particle size distribution at which the cumulative volume accumulated from the side of small particle sizes reaches 50% of the total volume. The volume-based particle size distribution may be obtained by measurement with a laser diffraction and scattering particle size distribution analyzer. Second active material particle 12 may have a D50 from 10 μm to 30 μm, or may have a D50 from 15 μm to 25 μm, for example.

(Electronic Conductor)

Electronic conductor 13 is placed on a surface of first active material particle 11. Electronic conductor 13 is in contact with first active material particle 11. At least part of electronic conductor 13 is embedded in solid electrolyte film 14. Substantially the entire electronic conductor 13 may be embedded in solid electrolyte film 14. Electronic conductor 13 may form an electron conduction path around first active material particle 11.

A part of electronic conductor 13 may be exposed from solid electrolyte film 14. With a part of electronic conductor 13 being exposed from solid electrolyte film 14, electron conduction paths for connecting first active material particle 11 and second active material particle 12 are expected to be increased. The part of electronic conductor 13 exposed from solid electrolyte film 14 may be in contact with second active material particle 12, or may be in contact with another, adjacent first active material particle 11.

As long as it is electronically conductive, electronic conductor 13 may include an optional component. Electronic conductor 13 may include a conductive carbon, a metal, and/or the like, for example. Electronic conductor 13 may have any configuration. Electronic conductor 13 may be fibers, particles, and/or the like, for example. Electronic conductor 13 may include a fibrous carbon 2, for example. Fibrous carbon 2 is expected to form electron conduction paths across a wide area. Electronic conductor 13 may include, for example, at least one selected from the group consisting of carbon nanotube (CNT), vapor grown carbon fiber (VGCF), graphene flake, carbon black, and metal nanoparticle. Here, CNT and VGCF correspond to fibrous carbon 2.

Fibrous carbon 2 may include a nano fiber, for example. The “nano fiber” herein refers to a substance that has a diameter from 0.1 nm to 100 nm and a length at least 2.5 times the diameter. The nano fiber may have a diameter of 1 nm or more, for example. The length of the nano fiber may be at least 100 times the diameter, for example. The diameters and the lengths of individual nano fibers may be measured with an STEM and/or the like. The arithmetic mean of 100 diameters is regarded as the diameter of the measured target. The arithmetic mean of 100 lengths is regarded as the length of the measured target. Fibrous carbon 2 may have a diameter from 0.4 nm to 50 nm, or may have a diameter from 0.6 nm to 10 nm, or may have a diameter from 0.8 nm to 1 nm, for example. Fibrous carbon 2 may have a length from 1 nm to 5 μm, or may have a length from 5 nm to 2 μm, or may have a length from 10 nm to 1 μm, for example.

Electronic conductor 13 may include a metal nanoparticle 1 and a fibrous carbon 2. For example, fibrous carbon 2 (such as CNT, for example) may be synthesized by using metal nanoparticle 1 as a catalyst. Fibrous carbon 2 may grow, starting from metal nanoparticle 1. In other words, fibrous carbon 2 extends, starting from metal nanoparticle 1. With fibrous carbon 2 extending toward outside, first active material particle 11 may become connected to an electronic conduction network.

Metal nanoparticle 1 may have a Feret diameter from 1 nm to 100 nm, for example. The Feret diameter of metal nanoparticle 1 may be smaller than the Feret diameter of first active material particle 11. Metal nanoparticle 1 may include, for example, at least one selected from the group consisting of copper (Cu), iron (Fe), cobalt (Co), nickel (Ni), gold (Au), and silver (Ag). Metal nanoparticle 1 may consist essentially of Cu, for example.

The amount of electronic conductor 13 to be used is not limited. The mass fraction of electronic conductor 13 to second active material particle 12 (graphite) may be from 0.01% to 5%, or may be from 0.1% to 3%, or may be from 0.5% to 2%, for example.

(Solid Electrolyte Film)

Solid electrolyte film 14 covers first active material particle 11. Solid electrolyte film 14 may cover a part of first active material particle 11. Solid electrolyte film 14 may cover substantially the entire first active material particle 11. In other words, solid electrolyte film 14 covers at least part of a surface of first active material particle 11. Solid electrolyte film 14 may have a thickness from 1 nm to 10 nm, for example. The thickness of solid electrolyte film 14 may be smaller than the length of electronic conductor 13, for example.

Solid electrolyte film 14 may be in contact with second active material particle 12. Solid electrolyte film 14 may bond first active material particle 11 and second active material particle 12 to each other. Solid electrolyte film 14 may bond adjacent first active material particles 11 to each other.

Solid electrolyte film 14 includes a solid electrolyte. For example, solid electrolyte film 14 may consist essentially of a solid electrolyte. The solid electrolyte is a Li-ion conductor. Because of this, solid electrolyte film 14 may form a Li-ion conduction path around first active material particle 11. The solid electrolyte may substantially be a non-conductor for electrons.

As long as it conducts Li ions, the solid electrolyte may include an optional component. The solid electrolyte may include, for example, at least one selected from the group consisting of a polymer Li-ion conductor, a sulfide Li-ion conductor, an oxide Li-ion conductor, a hydride Li-ion conductor, and an ionic liquid (a solid phase). The polymer Li-ion conductor may have plasticity. Because of this, the polymer Li-ion conductor is expected to be capable of following the volume change of the alloy-based negative electrode active material. Further, the polymer Li-ion conductor tends to be miscible with first active material particle 11, fibrous carbon 2, and/or the like. A repeating unit constituting the polymer Li-ion conductor may include an ether bond, for example. A polymer Li-ion conductor including an ether bond tends to have a high ionic conductivity. The polymer Li-ion conductor may include polyethylene oxide (PEO) and/or the like, for example.

The sulfide Li-ion conductor may have a high ionic conductivity. The sulfide Li-ion conductor may include Li₃PS₄(0.75Li₂S-0.25P₂S₅) and/or the like, for example. In addition to Li₃PS₄, the sulfide Li-ion conductor may further include a lithium halide (such as LiI and LiBr), for example.

The oxide Li-ion conductor may include Li₇La₃Zr₂O₁₂(LLZO) and/or the like, for example. The hydride Li-ion conductor may include LiBH₄ and/or the like, for example.

<<Second Composite Particle>>

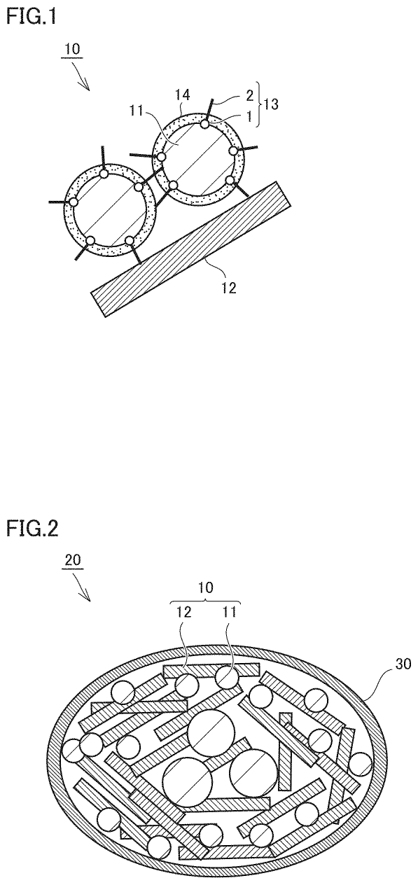

FIG. 2 is a conceptual view illustrating a second composite particle according to the present embodiment.

A plurality of first composite particles 10 may be aggregated to form a second composite particle 20. Second composite particle 20 may have a D50 from 1 μm to 50 μm, for example. In FIG. 2, for the sake of convenience, electronic conductor 13 and solid electrolyte film 14 (see FIG. 1) are not illustrated.

(Placing First Active Material Particle)

A plurality of first active material particles 11 (alloy-based negative electrode active material) are enclosed within second composite particle 20. A plurality of first active material particles 11 are dispersed inside second composite particle 20. With a plurality of first active material particles 11 being dispersed, the utilization rate of the alloy-based negative electrode active material is expected to be enhanced, for example.

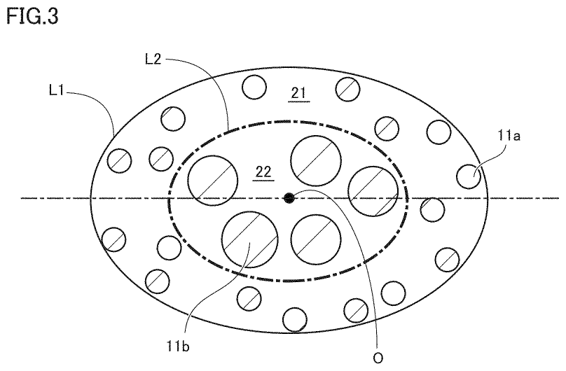

FIG. 3 is a conceptual view illustrating a surface region and a central region.

In FIG. 3, for the sake of convenience, second active material particle 12 is not illustrated. Second composite particle 20 may include a surface region 21 and a central region 22. For example, when the particle size of first active material particles 11 placed in surface region 21 is different from the particle size of first active material particles 11 placed in central region 22, various performances are expected to be improved.

For example, first active material particles 11 of a relatively small particle size (small particles 11a) may be placed in surface region 21. Small particles 11a may contribute to improving output. Small particles 11a may have a Feret diameter from 1 nm to 25 nm, or may have a Feret diameter from 10 nm to 15 nm, for example. For example, first active material particles 11 of a relatively large particle size (large particles 11b) may be placed in central region 22. Large particles 11b may contribute to increasing capacity. Large particles 11b may have a Feret diameter from 100 nm to 1 μm, for example.

By changing the relationship in quantity between small particles 11a in surface region 21 and large particles 11b in central region 22, it is possible to adjust the balance between output and capacity. For example, the balance between output and capacity may be adjusted in accordance with the applications of the battery. For example, for applications where output is important, small particles 11a may be placed in surface region 21 with a relatively high density. For example, for applications where capacity is important, large particles 11b may be placed in central region 22 with a relatively high density.

“Surface region 21” and “central region 22” herein are defined as follows. A cross-sectional image of second composite particle 20 is acquired. A cross-sectional sample may be prepared by CP (cross-section polisher), FIB (focused ion beam), and/or the like, for example. The cross-sectional image may be acquired with an SEM (scanning electron microscope) and/or the like, for example. In the cross-sectional image of second composite particle 20, the geometric center (0) is identified. Central region 22 shares the geometric center (0). Central region 22 has a similar figure to the cross-sectional image of second composite particle 20. The ratio of similitude is 0.6. Surface region 21 is a region sandwiched between the contour of second composite particle 20 (L1) and the contour of central region 22 (L2).

In the cross-sectional image of second composite particle 20, the number of small particles 11a relative to the area of surface region 21, for example, may be defined as the density of small particles 11a in surface region 21. The number of large particles 11b relative to the area of central region 22, for example, may be defined as the density of large particles 11b in central region 22.

<<Amorphous Carbon Film>>

The negative electrode active material may further include an amorphous carbon film 30. Amorphous carbon film 30 may cover second composite particle 20. With second composite particle 20 being covered with amorphous carbon film 30, graphite cycling performance and/or storage properties is expected to be enhanced, for example. Amorphous carbon film 30 may cover a part of second composite particle 20. Amorphous carbon film 30 may cover substantially the entire second composite particle 20. In other words, amorphous carbon film 30 covers at least part of a surface of second composite particle 20. Amorphous carbon film 30 may have a thickness from 1 nm to 1 μm, for example.

Amorphous carbon film 30 includes amorphous carbon. Amorphous carbon film 30 may consist essentially of amorphous carbon, for example. The amorphous carbon may include carbonized pitch and/or the like, for example.

<Method of Producing Negative Electrode Active Material>

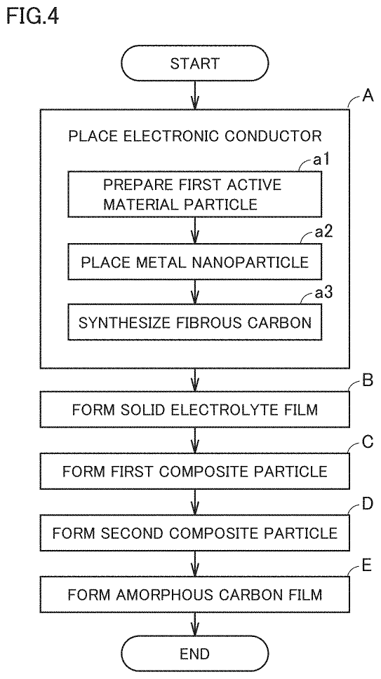

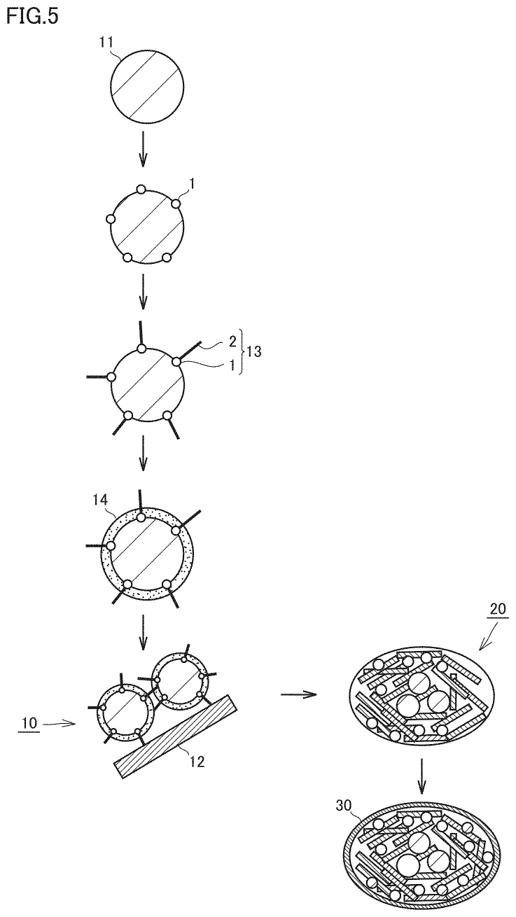

FIG. 4 is a schematic flowchart illustrating a method of producing a negative electrode active material according to the present embodiment.

A method of producing a negative electrode active material according to the present embodiment includes “(A) placing an electronic conductor”, “(B) forming a solid electrolyte film”, and “(C) forming a first composite particle”. The method of producing a negative electrode active material according to the present embodiment may further include “(D) forming a second composite particle” and “(E) forming an amorphous carbon film”, for example.

<<(A) Placing Electronic Conductor>>

The method of producing a negative electrode active material according to the present embodiment may include “(a1) preparing a first active material particle”, “(a2) placing a metal nanoparticle”, and “(a3) synthesizing fibrous carbon”, for example.

(a1) Preparing First Active Material Particle

FIG. 5 illustrates a concept of the flow of a method of producing a negative electrode active material according to the present embodiment.

First active material particle 11 is prepared. First active material particle 11 includes an alloy-based negative electrode active material. The details of first active material particle 11 are as described above.

(a2) Placing Metal Nanoparticle

Metal nanoparticle 1 may be placed on a surface of first active material particle 11. For example, first active material particle 11 is immersed in an aqueous solution of a metal salt to prepare a mixture. The mixture is dried to prepare a dry solid. The dry solid may be subjected to hydrogen reduction to cause a metal nanoparticle to be placed on a surface of first active material particle 11. For example, when the metal salt is copper sulfate, Cu nanoparticles may be placed.

(a3) Synthesizing Fibrous Carbon

Fibrous carbon 2 may be synthesized by using metal nanoparticle 1 as a catalyst. Thus, electronic conductor 13 may be formed. More specifically, electronic conductor 13 may be placed on a surface of first active material particle 11.

For example, after metal nanoparticle 1 is placed, first active material particle 11 is mixed with a carbon source. For example, first active material particle 11 may be immersed in ethanol and/or the like. First active material particle 11 to which the carbon source is adhered is subjected to heat treatment. For example, a tube furnace and/or the like may be used. Thus, fibrous carbon 2 is synthesized, starting from metal nanoparticle 1. Fibrous carbon 2 may grow in a direction away from metal nanoparticle 1.

<<(B) Forming Solid Electrolyte Film>>

The method of producing a negative electrode active material according to the present embodiment includes, after placing electronic conductor 13, covering first active material particle 11 with solid electrolyte film 14.

For example, a polymer solution is prepared. The polymer solution includes a polymer Li-ion conductor (a solute) and a solvent. For example, a PEO solution may be prepared. In the polymer solution, first active material particle 11 is immersed. First active material particle 11 to which the polymer solution is adhered may be dried to form solid electrolyte film 14 on a surface of first active material particle 11. At this time, it seems that at least part of electronic conductor 13 is embedded in solid electrolyte film 14.

<<(C) Forming First Composite Particle>>

The method of producing a negative electrode active material according to the present embodiment includes forming first composite particle 10 by causing second active material particle 12 to support first active material particle 11 covered with solid electrolyte film 14.

Second active material particle 12 is prepared. Second active material particle 12 includes graphite. The details of second active material particle 12 are as described above. For example, graphite flakes may be prepared as second active material particle 12. Second active material particle 12 and first active material particle 11 are mixed in an organic solvent. Thus, first active material particle 11 may be made to adhere to a surface of second active material particle 12. More specifically, first composite particle 10 may be formed.

For example, porous graphite may be prepared as second active material particle 12. First active material particles 11 are dispersed in an organic solvent to prepare a particle dispersion. Second active material particle 12 is immersed in the particle dispersion. Thus, first active material particles 11 may enter into second active material particle 12 (porous graphite). More specifically, first active material particles 11 may be placed inside the pores within second active material particle 12. For example, second active material particle 12 may be immersed, in steps, in multiple particle dispersions containing the dispersoid (first active material particle 11) of different particle sizes, to achieve different particle sizes of first active material particle 11 in surface region 21 and in central region 22. For example, second active material particle 12 may be immersed, in steps, in multiple particle dispersions containing the dispersoid in different concentrations, to achieve different densities of first active material particle 11 in surface region 21 and in central region 22.

The dispersoid may be a precursor of first active material particle 11. For example, porous graphite may be impregnated with SiO. After impregnation, SiO may be reduced to Si. The number of times of impregnation, the drying conditions, the type of the precursor, and/or the like may be changed to control the placing of first active material particle 11.

<<(D) Forming Second Composite Particle>>

The method of producing a negative electrode active material according to the present embodiment may include forming second composite particle 20 by, for example, aggregating a plurality of first composite particles 10. Formation of first composite particle 10 and formation of second composite particle 20 may be carried out substantially at the same time.

For example, in the case where second active material particles 12 are graphite flakes, spheronization treatment may be performed on first composite particles 10. By the spheronization treatment, the graphite flakes are folded while being aggregated. Thus, second composite particle 20 may be formed. First active material particles 11 may be enclosed within second composite particle 20.

The “spheronization treatment” herein refers to a treatment for making the outer shape of the particles closer to spherical. For example, a treatment known as graphite spheronization treatment may be employed. For example, a high-speed air-flow impact method and/or the like may be carried out to perform the spheronization treatment. As the treatment apparatus, “Hybridization System” manufactured by Nara Machinery Co., Ltd. may be used, for example.

In the spheronization treatment, formation of first composite particles 10 and formation of second composite particle 20 (aggregation and spheronization of first composite particles 10) may proceed substantially at the same time. For example, first active material particle 11 (an alloy-based negative electrode active material), a binder, second active material particle 12 (graphite), and a dispersion medium may be mixed to prepare a particle dispersion. The binder may include polyacrylonitrile (PAN) and/or the like, for example. The dispersion medium may include N-methyl-2-pyrrolidone (NMP) and/or the like, for example. The particle dispersion may be introduced into the treatment apparatus to perform spheronization treatment.

For example, multiple particle dispersions having different particle sizes of first active material particle 11 may be introduced, in steps, into the treatment apparatus, to achieve different particle sizes of first active material particle 11 in surface region 21 and in central region 22. For example, multiple particle dispersions having different concentrations of first active material particle 11 may be introduced, in steps, into the treatment apparatus, to achieve different densities of first active material particle 11 in surface region 21 and in central region 22.

<<(E) Forming Amorphous Carbon Film>>

The method of producing a negative electrode active material according to the present embodiment may include covering second composite particle 20 with amorphous carbon film 30.

For example, a pitch is prepared. Second composite particle 20 and the pitch are mixed while being heated. The amount of the pitch to be used may be, for example, from 0.1 parts by mass to 10 parts by mass relative to 100 parts by mass of second composite particle 20. The mixture is subjected to heat treatment in an inert atmosphere. The heat treatment temperature may be from 800° C. to 1000° C., for example. By the heat treatment, degradation reaction of the pitch proceeds. Thus, amorphous carbon film 30 may be formed.

<Lithium-Ion Battery>

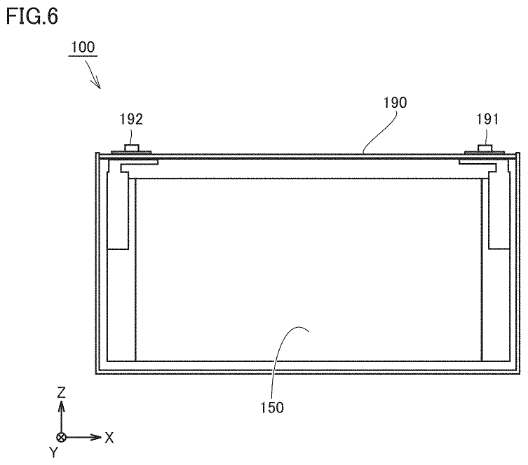

FIG. 6 is a schematic view illustrating an example of a lithium-ion battery according to the present embodiment.

A battery 100 includes the negative electrode active material according to the present embodiment. Battery 100 may have a high capacity. Battery 100 may be used for any purpose of use. For example, battery 100 may be used as a main electric power supply or a motive force assisting electric power supply in an electric vehicle. A plurality of batteries 100 may be connected together to form a battery module or a battery pack.

Battery 100 includes a housing 190. Housing 190 is prismatic (a flat, rectangular parallelepiped). However, prismatic is merely an example. Housing 190 may be cylindrical or may be a pouch, for example. Housing 190 may be made of Al alloy, for example. Housing 190 accommodates an electrode assembly 150 and an electrolyte solution (not illustrated). Electrode assembly 150 is connected to a positive electrode terminal 191 and a negative electrode terminal 192.

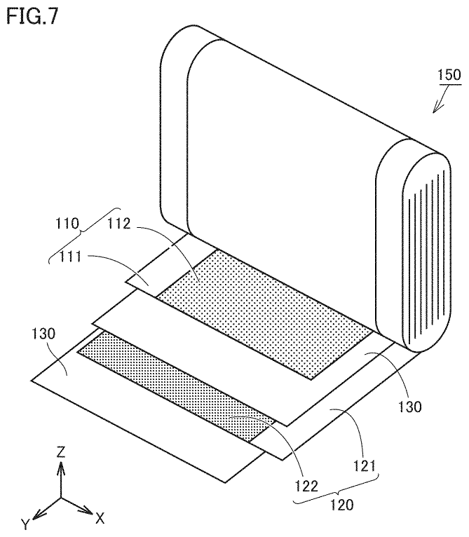

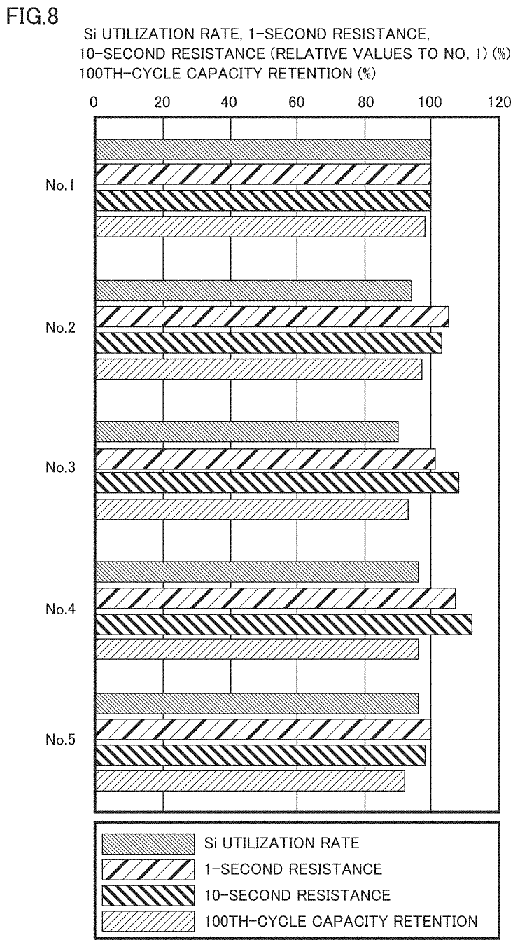

FIG. 7 is a schematic view illustrating an example of an electrode assembly according to the present embodiment.

Electrode assembly 150 is a wound-type one. Electrode assembly 150 includes a positive electrode 110, a separator 130, and a negative electrode 120. In other words, battery 100 includes positive electrode 110, negative electrode 120, and an electrolyte solution. Each of positive electrode 110, separator 130, and negative electrode 120 is a belt-shaped sheet. Electrode assembly 150 may include a plurality of separators 130. Electrode assembly 150 is formed by stacking positive electrode 110, separator 130, and negative electrode 120 in this order and then winding them spirally. Positive electrode 110 or negative electrode 120 may be interposed between separators 130. Each of positive electrode 110 and negative electrode 120 may be interposed between separators 130. After the winding, electrode assembly 150 is shaped into a flat form. The wound-type is merely an example. Electrode assembly 150 may be a stack-type one, for example.

<<Negative Electrode>>

Negative electrode 120 includes a negative electrode active material layer 122. Negative electrode 120 may further include a negative electrode substrate 121. For example, negative electrode active material layer 122 may be placed on the surface of negative electrode substrate 121. Negative electrode active material layer 122 may be placed on only one side of negative electrode substrate 121. Negative electrode active material layer 122 may be placed on both sides of negative electrode substrate 121. Negative electrode substrate 121 is a conductive sheet. Negative electrode substrate 121 may include a Cu foil and/or the like, for example. Negative electrode substrate 121 may have a thickness from 5 μm to 30 μm, for example.

Negative electrode active material layer 122 may have a thickness from 10 μm to 100 μm, for example. Negative electrode active material layer 122 includes a negative electrode active material. For example, negative electrode active material layer 122 may consist essentially of a negative electrode active material. In addition to the negative electrode active material, negative electrode active material layer 122 may further include a conductive material, a binder, and the like. The conductive material may include carbon black, CNT, and/or the like, for example. The amount of the conductive material to be used may be, for example, from 0.1 parts by mass to 10 parts by mass relative to 100 parts by mass of the negative electrode active material. The binder may include carboxymethylcellulose (CMC), styrene-butadiene rubber (SBR), and/or the like, for example. The amount of the binder to be used may be, for example, from 0.1 parts by mass to 10 parts by mass relative to 100 parts by mass of the negative electrode active material.

<<Positive Electrode>>

Positive electrode 110 includes a positive electrode active material layer 112. Positive electrode 110 may further include a positive electrode substrate 111. For example, positive electrode active material layer 112 may be placed on the surface of positive electrode substrate 111. Positive electrode active material layer 112 may be placed on only one side of positive electrode substrate 111. Positive electrode active material layer 112 may be placed on both sides of positive electrode substrate 111. Positive electrode substrate 111 is a conductive sheet. Positive electrode substrate 111 may include an Al foil and/or the like, for example. Positive electrode substrate 111 may have a thickness from 10 μm to 30 μm, for example.

Positive electrode active material layer 112 may have a thickness from 10 μm to 100 μm, for example. Positive electrode active material layer 112 includes a positive electrode active material. For example, positive electrode active material layer 112 may consist essentially of a positive electrode active material. The positive electrode active material may include an optional component. The positive electrode active material may include, for example, at least one selected from the group consisting of LiCoO₂, LiNiO₂, LiMnO₂, LiMn₂O₄, Li(NiCoMn)O₂, Li(NiCoAl)O₂, and LiFePO₄. Here, the expression “(NiCoMn)” in the composition formula “Li(NiCoMn)O₂”, for example, means that the constituents within the parentheses are collectively regarded as a single unit in the entire composition ratio. As long as (NiCoMn) is collectively regarded as a single unit in the entire composition ratio, the composition ratios between the elements (Ni, Co, Mn) are not particularly limited. In addition to the positive electrode active material, positive electrode active material layer 112 may further include a conductive material, a binder, and the like. The conductive material may include carbon black and/or the like, for example. The amount of the conductive material to be used may be, for example, from 0.1 parts by mass to 10 parts by mass relative to 100 parts by mass of the positive electrode active material. The binder may include polyvinylidene difluoride (PVdF) and/or the like, for example. The amount of the binder to be used may be, for example, from 0.1 parts by mass to 10 parts by mass relative to 100 parts by mass of the positive electrode active material.

<<Separator>>

At least part of separator 130 is interposed between positive electrode 110 and negative electrode 120. Separator 130 separates positive electrode 110 from negative electrode 120. Separator 130 may have a thickness from 10 μm to 30 μm, for example.

Separator 130 is porous. Separator 130 allows for permeation of the electrolyte solution therethrough. Separator 130 may have an air permeability from 200 s/100 mL to 400s/100 mL, for example. The “air permeability” herein refers to the “air resistance” defined in “JIS P8117:2009”. The air permeability is measured by a Gurley test method.

Separator 130 is electrically insulating. Separator 130 may include a polyolefin-based resin and/or the like, for example. Separator 130 may consist essentially of a polyolefin-based resin, for example. The polyolefin-based resin may include, for example, at least one selected from the group consisting of polyethylene (PE) and polypropylene (PP). Separator 130 may have a monolayer structure, for example. Separator 130 may consist essentially of a PE layer, for example. Separator 130 may have a multilayer structure, for example. Separator 130 may be formed by, for example, stacking a PP layer, a PE layer, and a PP layer in this order. On a surface of separator 130, a heat-resistant layer and/or the like may be formed, for example.

<<Electrolyte Solution>>

The electrolyte solution is a liquid electrolyte. The electrolyte solution includes a solvent and a supporting electrolyte. The solvent is aprotic. The solvent may include an optional component. The solvent may include, for example, at least one selected from the group consisting of ethylene carbonate (EC), propylene carbonate (PC), butylene carbonate (BC), monofluoroethylene carbonate (FEC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. The supporting electrolyte may include, for example, at least one selected from the group consisting of LiPF₆, LiBF₄ and LiN(FSO₂)₂. The supporting electrolyte may have a molarity from 0.5 mol/L to 2.0 mol/L, for example. The supporting electrolyte may have a molarity from 0.8 mol/L to 1.2 mol/L, for example.

The electrolyte solution may further include an optional additive. The mass fraction of the additive to the electrolyte solution may be from 0.01% to 5%, for example. The additive may include, for example, at least one selected from the group consisting of vinylene carbonate (VC), lithium difluorophosphate (LiPO₂F₂), lithium fluorosulfonate (FSO₃Li), and lithium bis(oxalato)borate (LiBOB).

### EXAMPLES

Next, examples according to the present technique (hereinafter also called “the present example”) will be described. It should be noted that the below description does not limit the scope of the present technique.

<Production of Negative Electrode Active Material>

Negative electrode active materials according to No. 1 to No. 5 were produced. The configuration of each negative electrode active material is found in Table 1 below. Each negative electrode active material is designed to have a specific capacity of 500 mAh/g. The specific capacity (theoretical value) of graphite of 372 mAh/g.

TABLE 1

| | First | Second | Electronic conductor | | | |
|---|---|---|---|---|---|---|
| | active | active | Metal | | Solid | |
| | material | material | nano- | Fibrous | electrolyte | |
| No. | particle | particle | particle | carbon | film | Composing |
| 1 | Si | Graphite | Cu | CNT | PEO | Composite |
| | | | particles | | | particles |
| 2 | Si | Graphite | — | — | PEO | Composite |
| | | | | | | particles |
| 3 | Si | Graphite | Cu | CNT | — | Composite |
| | | | particles | | | particles |
| 4 | Si | Graphite | — | — | — | Composite |
| | | | | | | particles |
| 5 | SiO | Graphite | — | — | — | Mixture |
| | | | | | | (No |
| | | | | | | Composing) |

The negative electrode active material according to No. 1 includes second composite particle 20 (see FIG. 2). Second composite particle 20 is covered with amorphous carbon film 30.

The negative electrode active material according to No. 2 does not include electronic conductor 13. Except this, it is the same as the negative electrode active material according to No. 1.

The negative electrode active material according to No. 3 does not include solid electrolyte film 14. Except this, it is the same as the negative electrode active material according to No. 1.

The negative electrode active material according to No. 4 includes neither electronic conductor 13 nor solid electrolyte film 14. Except this, it is the same as the negative electrode active material according to No. 1.

The negative electrode active material according to No. 5 is a simple mixture of SiO and graphite. Composite particles are not formed.

<Evaluation>

<<Utilization Rate of Alloy-Based Negative Electrode Active Material>>

With each negative electrode active material, a test cell (a lithium-ion battery) was fabricated. After the test cell was activated, three cycles of full-range charge and discharge were carried out. The 3rd-cycle discharge curve (delithiation from the negative electrode) was analyzed to estimate the utilization rate of Si (an alloy-based negative electrode active material). In the present example, from the differentiated discharge curve (dV/dQ curve), the Si utilization rate was estimated. It seems possible to estimate the Si utilization rate also from the charge-discharge curve, the dQ/dV curve, EDS (energy dispersive x-ray spectroscopy), EELS (electron energy loss spectroscopy), and/or the like.

<<Other>>

The test cell was subjected to measurement of 1-second resistance, 10-second resistance, and 100th-cycle capacity retention.

<Results>

FIG. 8 is a bar chart for evaluation results.

The “Si utilization rate” is defined as a relative value to the value of No. 1 (which is regarded as 100%). The higher the “Si utilization rate” is, the more enhanced the utilization rate of the alloy-based negative electrode active material is considered to be. Among all the samples, the negative electrode active material according to No. 1 exhibited the highest utilization rate.

Each of “1-second resistance” and “10-second resistance” is defined as a relative value to the value of No. 1 (which is regarded as 100%). The lower the “1-second resistance” and the “10-second resistance” are, the better the input-output properties are considered to be. The negative electrode active material according to No. 1 exhibited a lower resistance than the negative electrode active materials according to No. 2 to No. 4.

For each test cell, the “100th-cycle capacity retention” is the percentage of a value obtained by dividing the 100th-cycle discharged capacity by the 3rd-cycle discharged capacity. Among all the samples, the negative electrode active material according to No. 1 exhibited the highest capacity retention.

The present embodiment and the present example are illustrative in any respect. The present embodiment and the present example are non-restrictive. The scope of the present technique encompasses any modifications within the meaning and the scope equivalent to the terms of the claims. For example, it is expected that certain configurations of the present embodiments and the present examples can be optionally combined. In the case where a plurality of functions and effects are described in the present embodiment and the present example, the scope of the present technique is not limited to the scope where all these functions and effects are obtained.

What is claimed is:

1. A negative electrode active material for a lithium-ion battery, comprising:
a first composite particle, wherein
the first composite particle includes a first active material particle, a second active material particle, an electronic conductor, and a solid electrolyte film,
the first active material particle includes an alloy-based negative electrode active material,
the second active material particle includes graphite,
the electronic conductor is placed on a surface of the first active material particle,
the solid electrolyte film covers the first active material particle,
at least part of the electronic conductor is embedded in the solid electrolyte film, and
the second active material particle supports the first active material particle, the solid electrolyte film, and the electronic conductor.

2. The negative electrode active material according to claim 1, wherein
a plurality of the first composite particles are aggregated to form a second composite particle, and
a plurality of the first active material particles are dispersed inside the second composite particle.

3. The negative electrode active material according to claim 2, wherein
the negative electrode active material further includes an amorphous carbon film, and
the amorphous carbon film covers the second composite particle.

4. The negative electrode active material according to claim 1, wherein a part of the electronic conductor is exposed from the solid electrolyte film.

5. The negative electrode active material according to claim 1, wherein the electronic conductor includes fibrous carbon.

6. The negative electrode active material according to claim 5, wherein
the electronic conductor further includes a metal nanoparticle,
the metal nanoparticle is placed on a surface of the first active material particle, and
the fibrous carbon extends, starting from the metal nanoparticle in a direction away from the metal nanoparticle.

7. A lithium-ion battery comprising the negative electrode active material according to claim 1.

8. A method of producing a negative electrode active material for a lithium-ion battery, the method comprising:
placing an electronic conductor on a surface of a first active material particle;
after the placing an electronic conductor, covering the first active material particle with a solid electrolyte film; and
forming a first composite particle by causing a second active material particle to support the first active material particle covered with the solid electrolyte film,
wherein
the first active material particle includes an alloy-based negative electrode active material, and
the second active material particle includes graphite.

9. The method of producing a negative electrode active material according to claim 8, wherein the method comprising:
placing a metal nanoparticle on the surface of the first active material particle; and
synthesizing fibrous carbon by using the metal nanoparticle as a catalyst to form the electronic conductor.

10. The method of producing a negative electrode active material according to claim 8, further comprising:
forming a second composite particle by aggregating a plurality of the first composite particles.

11. The method of producing a negative electrode active material according to claim 10, further comprising:
performing spheronization treatment on the second composite particle.

12. The method of producing a negative electrode active material according to claim 10, further comprising:
covering the second composite particle with an amorphous carbon film.
